(19) United States
(12) Patent Application Publication
(10) Pub. No.: US 2023/0059197 A1
(43) Pub. Date: Feb. 23, 2023

(54) MOVABLE BODY CONTROL SYSTEM, CONTROL APPARATUS, CONTROL METHOD AND RECORDING MEDIUM

(71) Applicant: NEC Corporation, Minato-ku, Tokyo (JP)

(72) Inventor: Takato Sekimoto, Tokyo (JP)

(73) Assignee: NEC Corporation, Minato-ku, Tokyo (JP)

(21) Appl. No.: 17/794,854

(22) PCT Filed: Mar. 10, 2021
(86) PCT No.: PCT/JP2021/009475

§ 371 Date: Jul. 22, 2022

(30) Foreign Application Priority Data
Mar. 17, 2020 (JP) 2020-046675

(51) Int. Cl. G05D 1/00; H04W 16/18

(52) U.S. Cl. CPC G05D 1/0022; G05D 1/0027; H04W 16/18

(57) ABSTRACT

A movable body control system (SYS) includes a movable body (1) that is movable in a predetermined area (TA) in which a wireless communication network (NW) is built; a control apparatus (6) for controlling the movable body through the wireless communication network; and a measurement apparatus (3) for measuring a communication quality of the wireless communication network in the predetermined area, the control apparatus includes a generation unit (613) for generating, as a target moving route (TGT) for the movable body, a first route avoiding a low quality area (DA1) in which the communication quality does not reach a desired quality in the predetermined area, based on a measured result by the measurement apparatus; and a control unit (614) for controlling the movable body so that the movable body moves along the target moving route.

### TECHNICAL FIELD

This disclosure relates to a technical field of a movable body control system, a control apparatus, a control method and a recording medium that are configured to control a movable body.

### BACKGROUND ART

A control apparatus that is configured to control a movable body that is configured to autonomously move in a facility such as a plant is known. For example, a Patent Literature 1 discloses a control apparatus that is configured to determine that a movable carriage is close to or contacts with a virtual obstacle at a point when a received signal strength is equal to or smaller than a predetermined value at this point during a period when the movable carriage that is one example of the movable body moves, and then to modify a route for the movable carriage so as to be closer to a target point while avoiding the virtual obstacle.

Additionally, there is a Patent Literature 2 to a Patent Literature 5 as a background art document related to this disclosure.

### Citation List

### Patent Literature

Patent Literature 1: JP2003-005833A
Patent Literature 2: JP2018-197731A
Patent Literature 3: JP2017-103586A
Patent Literature 4: JP2012-137909A
Patent Literature 5: JP2011-166671A

### Technical Problem

The control apparatus disclosed in the Patent Literature 1 modifies the route for the movable body only after the received signal strength is equal to or smaller than the predetermined value at the point at which the movable body such as the movable carriage is actually located. Namely, the route for the movable body is modified after a communication of the movable body is unstable. Thus, the control apparatus disclosed in the Patent Literature 1 has a room for an improvement in a generation of a moving route for the movable body.

It is an example object of this disclosure to provide a movable body control system, a control apparatus, a control method and a recording medium that are configured to solve the above described technical problem. As one example, it is an example object of this disclosure to provide a movable body control system, a control apparatus, a control method and a recording medium that are configured to properly generate a moving route for a movable body.

### Solution to Problem

One example aspect of a movable body control system includes a movable body that is movable in a predetermined area in which a wireless communication network is built; a control apparatus that is configured to control the movable body through the wireless communication network; and a measurement apparatus that is configured to measure a communication quality of the wireless communication network in the predetermined area, the control apparatus includes: a generation unit that is configured to generate, as a target moving route for the movable body, a first route avoiding a low quality area in which the communication quality does not reach a desired quality in the predetermined area, based on a measured result by the measurement apparatus; and a control unit that is configured to control the movable body so that the movable body moves along the target moving route.

One example aspect of a control apparatus is a control apparatus that is configured to control, through a wireless communication network, a movable body that is movable in a predetermined area in which the wireless communication network is built, the control apparatus includes: a generation unit that is configured to generate, as a target moving route for the movable body, a first route avoiding a low quality area in which a communication quality does not reach a desired quality in the predetermined area, based on a measured result of the communication quality of the wireless communication network in the predetermined area; and a control unit that is configured to control the movable body so that the movable body moves along the target moving route.

One example aspect of a control method is a control method of controlling, through a wireless communication network, a movable body that is movable in a predetermined area in which the wireless communication network is built, the control method includes: generating, as a target moving route for the movable body, a first route avoiding a low quality area in which a communication quality does not reach a desired quality in the predetermined area, based on a measured result of the communication quality of the wireless communication network in the predetermined area; and controlling the movable body so that the movable body moves along the target moving route.

One example aspect of a recording medium is a recording medium on which a computer program that allows a computer to execute a control method is recorded, wherein the control method is a control method of controlling, through a wireless communication network, a movable body that is movable in a predetermined area in which the wireless communication network is built, and includes: generating, as a target moving route for the movable body, a first route avoiding a low quality area in which a communication quality does not reach a desired quality in the predetermined area, based on a measured result of the communication quality of the wireless communication network in the predetermined area; and controlling the movable body so that the movable body moves along the target moving route.

### Effect

The movable body control system, the control apparatus, the control method and the recording medium described above are capable of properly generating the moving route for the movable body.

### BRIEF DESCRIPTION OF DRAWINGS

FIG. 1 is a block diagram that illustrates an entire configuration of a movable body control system in a present example embodiment.

FIG. 2 is a planar view that conceptually illustrates a transport area to which the movable body control system in the present example embodiment is applied.

FIG. 3 is a block diagram that illustrates a configuration of a movable body in the present example embodiment.

FIG. 4 is a block diagram that illustrates a configuration of a control server in the present example embodiment.

FIG. 5 is a flow chart that illustrates a flow of a first movable body control operation that is performed at a timing at which each movable body starts to move in the transport area.

FIG. 6 is a planar view that illustrates one example of a movement map in which a signal strength is mapped.

FIG. 7 is a planar view that illustrates one example of a target moving route satisfying a signal strength condition.

FIG. 8 is a flow chart that illustrates a flow of a second movable body control operation that is performed after each movable body starts to move in the transport area.

FIG. 9A is a planar view that illustrates, on the movement map that is not yet updated, the target moving route generated before the movement map is updated, FIG. 9B is a planar view that illustrates, on the movement map that is already updated, the target moving route generated before the movement map is updated, and FIG. 9C is a planar view that illustrates, on the movement map that is already updated, the target moving route regenerated after the movement map is updated.

FIG. 10A is a planar view that illustrates, on the movement map that is not yet updated, the target moving route generated before the movement map is updated, FIG. 10B is a planar view that illustrates, on the movement map that is already updated, the target moving route generated before the movement map is updated, and FIG. 10C is a planar view that illustrates, on the movement map that is already updated, a wireless access point that performs a beamforming.

FIG. 11 is a block diagram that illustrates an entire configuration of a movable body control system in a modified example.

FIG. 12 is a block diagram that illustrates a configuration of a control server in the modified example.

### DESCRIPTION OF EXAMPLE EMBODIMENTS

Next, an example embodiment of a movable body control system, a control apparatus, a control method and a recording medium will be described with reference to the drawings. In the below described description, the example embodiment of the movable body control system, the control apparatus, the control method and the recording medium will be described by using a movable body control system SYS that is configured to control movements of a plurality of movable bodies 1 that are movable in a transport area TA in a warehouse.

However, the movable body control system SYS may be configured to control any movable body 1 that is movable in any area. For example, the movable body control system SYS may be configured to control any movable body 1 that is movable in any area in at least one of a factory, a hospital, a station, an airport and a shopping mall.

### Configuration of Movable Body Control System SYS

### 1) Entire Configuration of Movable Body Control System SYS

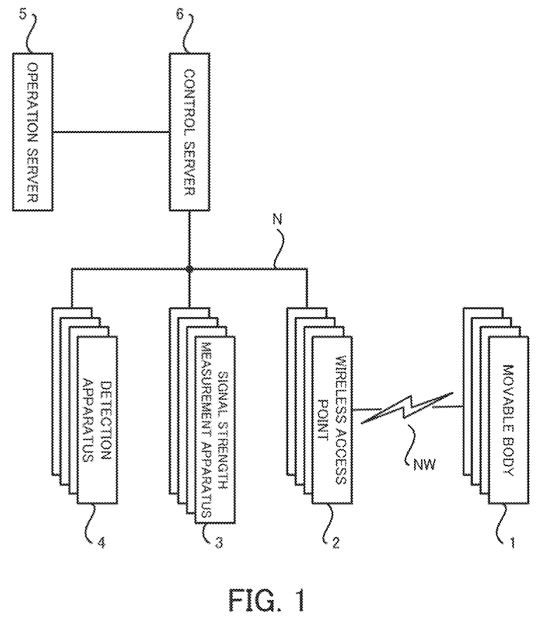

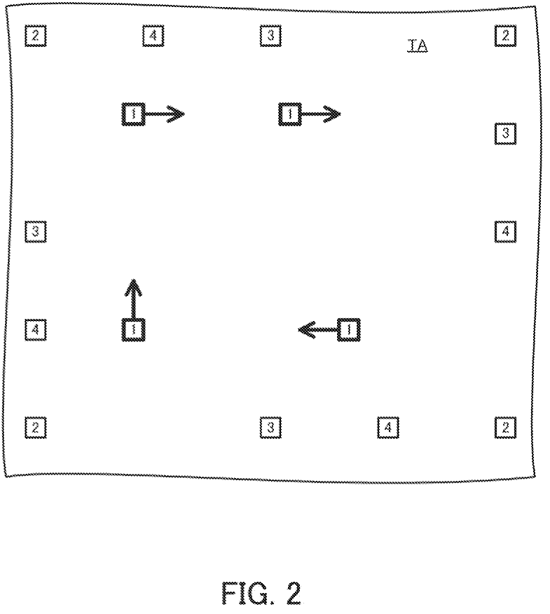

Firstly, with reference to FIG. 1 and FIG. 2, an entire configuration of the movable body control system SYS in the present example embodiment will be described. FIG. 1 is a block diagram that illustrates an entire configuration of the movable body control system SYS in the present example embodiment. FIG. 2 is a planar view that conceptually illustrates the transport area TA to which the movable body control system SYS in the present example embodiment is applied.

As illustrated in FIG. 1, the movable body control system SYS includes a plurality of movable bodies 1, a plurality of wireless access points 2, a plurality of signal strength measurement apparatuses 3 each of which is one specific example of a “measurement apparatus”, a plurality of detection apparatuses 4, an operation server 5 that is one specific example of a “control apparatus”, and a control server 6 that is one specific example of a “control apparatus”. However, the movable body control SYS may include a single movable body 1. The movable body control SYS may include a single wireless access point 2. The movable body control SYS may include a single signal strength measurement apparatus 3. The movable body control SYS may include a single detection apparatus 4.

As illustrated in FIG. 2, the plurality of movable bodies 1, the plurality of wireless access points 2, the plurality of signal strength measurement apparatuses 3 and the plurality of detection apparatuses 4 are located in the transport area TA. On the other hand, operation server 5 and the control server 6 may not be located in the transport area TA. For example, the operation server 5 and the control server 6 may be located in a management room or a server room prepared in the warehouse or outside the warehouse.

Each movable body 1 is autonomously movable in the transport area TA under the control of the control server 6. Specifically, each movable body 1 is autonomously movable along a target moving route TGT generated by the control server 6 in the transport area TA. An Automated Guided Vehicle is one example of the movable body 1. In this case, the movable body 1 may move in the transport area TA to transport an item.

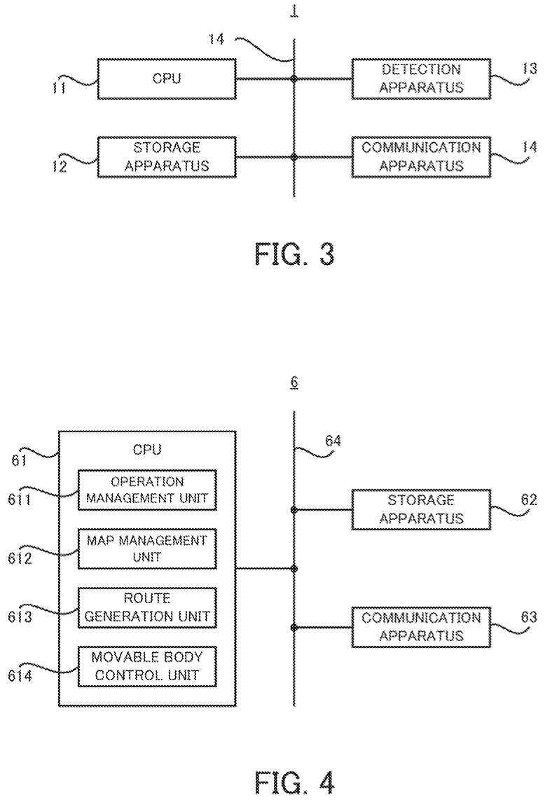

Each movable body 1 includes a CPU (Central Processing Unit) 11, a storage apparatus 12, a detection apparatus 13 and a communication apparatus 14, as illustrated in FIG. 3 that is a block diagram illustrating a configuration of the movable body 1. However, the movable body 1 may not include the detection apparatus 13. The CPU 11, the storage apparatus 12, the detection apparatus 13 and the communication apparatus 14 may be interconnected through a data bus 15.

The CPU 11 reads a computer program. For example, the CPU 11 may read a computer program stored in the storage apparatus 12. For example, the CPU 11 may read a computer program stored in a computer-readable recording medium, by using a not-illustrated recording medium reading apparatus. The CPU 11 may obtain (namely, download or read) a computer program from a not-illustrated apparatus placed outside the movable body 1 through the communication apparatus 14. The CPU 11 executes the read computer program. As a result, a logical functional block for autonomously moving under the control of the control server 6 is implemented in the CPU 11. Namely, the CPU 11 is configured to serve as a controller for implementing the logical block for autonomously moving under the control of the control server 6.

The storage apparatus 12 is configured to store desired data. For example, the storage apparatus 12 may temporarily store the computer program that is executed by the CPU 11. The storage apparatus 12 may temporarily store data temporarily used by the CPU 11 when the CPU 11 executes the computer program. The storage apparatus 12 may store data stored for a long term by the movable body 1. The storage apparatus 12 may include at least one of a RAM (Random Access Memory), a ROM (Read Only Memory), a hard disk apparatus, a magneto-optical disc, a SSD (Solid State Drive) and a disk array apparatus.

The detection apparatus 13 is configured to detect an object around the movable body 1. At least one of a camera, a radar and an infrared radiation sensor is one example of the detection apparatus 13. At least one of a human, an obstacle and other movable body 1 is one example of the object around the movable body 1. A detected result by the detection apparatus 13 (namely, a detected result of the object) may be used by the CPU 11 in order to allow the movable body 1 to autonomously move so as to prevent a collision between the movable body 1 and the object detected by the detection apparatus 13.

The communication apparatus 14 is configured to communicate with the control server 6 through a wireless communication network NW that is built by the plurality of wireless access points 2. Especially in the present example embodiment, the communication apparatus 14 may transmit the detected result by the detection apparatus 13 to the control server through the wireless communication network NW. In this case, the detected result by the detection apparatus 13 may be used by the control server 6 to determine the target moving route TGT for the movable body 1. Furthermore, the communication apparatus 14 is configured to receive a control information from the control server 6 (specifically, a command signal that is transmitted to the movable body 1 from the control server 6 to control the movable body 1) through the wireless communication network NW. The CPU 11 may control at least one of a driving unit (for example, a motor), a braking unit and a steering unit of the movable body 1 so that the movable body 1 autonomously moves based on the received control information.

Again in FIG. 1 and FIG. 2, each wireless access point 2 builds the wireless communication network NW in the transport area TA. Each wireless access point 2 is configured to wirelessly communicate with the movable body 1 located in a communication cell of each wireless access point 2. The movable body 1 is configured to communicate with the control server 6 through the wireless communication network NW built by the plurality of wireless access points 2. The movable body 1 is configured to communicate with the control server 6 through a communication network N including at least one of the plurality of wireless access points 2. Thus, each wireless access point 2 is connected to the control server 6 to communicate with it through at least one of a wired communication network and a wireless communication network. Since the plurality of movable bodies 1 move in the transport area TA, it is preferable that the plurality of wireless access points 2 be located discretely in the transport area TA.

It is preferable that each wireless access point 2 be configured to perform a beamforming (namely, have a beamforming function). Namely, it is preferable that each wireless access point 2 be configured to increase a directionality of a wireless radio wave directed toward a specific direction by controlling the directionality of the wireless radio wave emitted from each wireless access point 2. However, each wireless access point 2 may not be configured to perform the beamforming.

Each signal strength measurement apparatus 3 is configured to measure the signal strength in the transport area TA (namely, a strength of a wireless radio wave used in the wireless communication network NW built by the plurality of wireless access points 2). Specifically, each signal strength measurement apparatus 3 measures the signal strength in a location (alternatively, near a location) at which each signal strength measurement apparatus 3 is located. As described later in detail, a measured result of the signal strength by each signal strength measurement apparatus 3 is mapped on a map indicating the transport area TA. Thus, it is preferable that the plurality of signal strength measurement apparatuses 3 be located discretely in the transport area TA. The communication quality of the wireless communication network NW built by the plurality of wireless access points 2 is better as the signal strength is higher. Thus, it can be said that an operation for measuring the signal strength in the transport area TA is one specific example of an operation for measuring the communication quality of the wireless communication network NW in the transport area TA. Note that each signal strength measurement apparatus 3 may measure the signal strength in the transport area TA by using an existing measurement method of the signal strength (for example, a measurement method disclosed in the Patent Literature 4 or the like). Each signal strength measurement apparatus 3 transmits the measured result by each signal strength measurement apparatus 3 (namely, the measured result of the signal strength) to the control server 6 through the wireless communication network NW built by the plurality of wireless access points 2 (alternatively, another communication network). The measured result by each signal strength measurement apparatus 3 may be used by the control server 6 to determine the target moving route TGT for the movable body 1.

Each detection apparatus 4 is configured to detect an object in the transport area TA. At least one of a camera, a radar and an infrared radiation sensor is one example of the detection apparatus 4. At least one of a human, an obstacle and the movable body 1 is one example of the object in the transport area TA. It is preferable that the plurality of detection apparatuses 4 be located discretely in the transport area TA. Each detection apparatus 4 transmits the detected result by each detection apparatus 4 (namely, a detected result of the object) to the control server 6 through the wireless communication network NW built by the plurality of wireless access points 2 (alternatively, another communication network). The detected result by each detection apparatus 4 may be used by the control server 6 to determine the target moving route TGT for the movable body 1.

The operation server 5 is configured to transmit, to the control server 6, an operation order information related to an operation that should be performed in the transport area TA based on an operation information related to an operation that is needed to be performed in the transport area TA.

The control server 6 performs a movable body control operation for controlling each movable body 1 so that each movable body 1 autonomously move in the transport area TA. The control server 6 includes a CPU 61, a storage apparatus 62 and a communication apparatus 63, as illustrated in FIG. 4 that is a block diagram illustrating a configuration of the control server 6. The CPU 61, the storage apparatus 62 and the communication apparatus 63 may be interconnected through a data bus 64.

The CPU 61 reads a computer program. For example, the CPU 61 may read a computer program stored in the storage apparatus 62. For example, the CPU 61 may read a computer program stored in a computer-readable recording medium, by using a not-illustrated recording medium reading apparatus. The CPU 61 may obtain (namely, download or read) a computer program from a not-illustrated apparatus placed outside the control server 6 through the communication apparatus 63. The CPU 61 executes the read computer program. As a result, a logical functional block for performing the movable body control operation that should be performed by the control server 6 is implemented in the CPU 61. Namely, the CPU 61 is configured to serve as a controller for implementing the logical block for performing the movable body control operation.

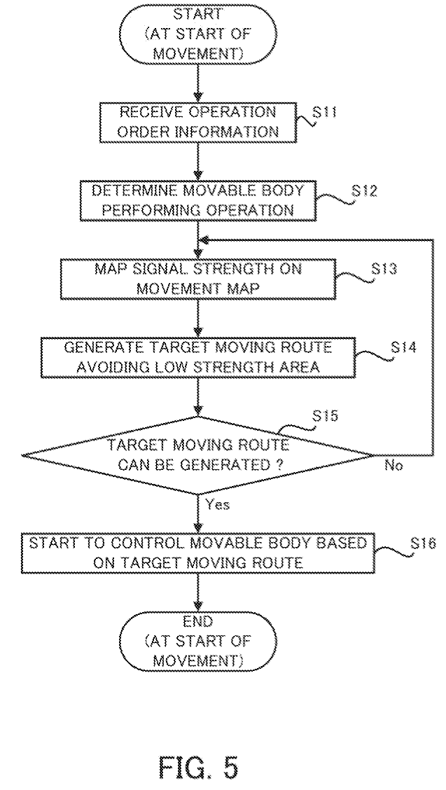

In order to perform the movable body control operation, an operation management unit 611, a map management unit 612, a route generation unit 613 that is one specific example of a “generation unit” and a movable body control unit 614 that is one specific example of a “control unit” are implemented in the CPU 61. Note that a detail of an operation of each of the operation management unit 611, the map management unit 612, the route generation unit 613 and the movable body control unit 614 will be described later in detail with reference to FIG. 5 to FIG. 10 and so on, however, an overview thereof will be briefly described here. The operation management unit 611 is configured to determine, based on the operation order information transmitted from the operation server 5, the movable body 1 that should perform the operation indicated by the operation order information. The map management unit 612 is configured to map the measured results by the plurality of signal strength measurement apparatuses 3 on a map (in the below described description, it is referred to as a “movement map MP”) indicating a layout of the transport area TA in which the movable body 1 moves. Namely, the map management unit 612 is configured to map, on the movement map MP, a magnitude of the signal strength in each area (in other words, at each location or each position) in the transport area TA based on the measured results by the plurality of signal strength measurement apparatuses 3. The route generation unit 613 is configured to generate the target moving route TGT of each movable body 1 in the transport area TA based on the movement map MP on which the signal strength is mapped and the detected results by the plurality of detection apparatuses 13 of the plurality of movable bodies 1. The movable body control unit 614 is configured to control each movable body 1 through the wireless communication network NW so that each movable body 1 moves along the generated target moving route TGT.

The storage apparatus 62 is configured to store desired data. For example, the storage apparatus 62 may temporarily store the computer program that is executed by the CPU 61. The storage apparatus 62 may temporarily store data temporarily used by the CPU 61 when the CPU 61 executes the computer program. The storage apparatus 62 may store data stored for a long term by the control server 6. The storage apparatus 62 may include at least one of a RAM, a ROM, a hard disk apparatus, a magneto-optical disc, a SSD and a disk array apparatus.

The communication apparatus 63 is configured to communicate with each of the plurality of movable bodies 1 through the wireless communication network NW. Especially in the present example embodiment, the communication apparatus 63 is configured to transmit the control information for controlling the movable body 1 (specifically, the command signal that is transmitted to the movable body 1 from the control server 6 to control the movable body 1). Each movable body 1 autonomously moves based on the control information transmitted from the control server 6.

Furthermore, the communication apparatus 63 is configured to communicate with each of the plurality of signal strength measurement apparatuses 3, the plurality of detection apparatuses 4 and the operation server 5 through the wireless communication network NW. For example, the communication apparatus 63 may receive the measured result by each signal strength measurement apparatus 3 from each signal strength measurement apparatus 3. For example, the communication apparatus 63 may receive the detected result by each detection apparatus 4 from each detection apparatus 4. For example, the communication apparatus 63 may receive the operation order information from the operation server 5.

### Operation of Control Server 6

Next, the movable body control operation performed by the control server 6 will be described. In the present example embodiment, the control server 6 may perform the movable body control operation at a timing when each movable body 1 starts to move in the transport area TA. Furthermore, the control server 6 may perform the movable body control operation after each movable body 1 starts to move in the transport area TA. Namely, the control server 6 may perform the movable body control operation during a period when each movable body 1 moves in the transport area TA. Thus, in the below described description, a first movable body control operation performed at the timing when each movable body 1 starts to move in the transport area TA and a second movable body control operation performed after each movable body 1 starts to move in the transport area TA will be described in order.

### 1) First Movable Body Control Operation (At a Timing When the Movable Body 1 Starts to Move)

Firstly, with reference to FIG. 5, the first movable body control operation performed at the timing when each movable body 1 starts to move in the transport area TA will be described. FIG. 5 is a flowchart that illustrates a flow of the first movable body control operation performed at the timing when each movable body 1 starts to move in the transport area TA. Note that the control server 6 performs the first movable body control operation individually (in other words, in parallel) for each of the plurality of movable bodies 1.

As illustrated in FIG. 5, the operation management unit 611 receives (namely, obtains) the operation order information from the operation server 5 through the communication apparatus 63 (a step S11). Then, the operation management unit 611 determines, based on the operation order information received at the step S11, the movable body 1 that performs the operation indicated by the operation order information from the plurality of movable bodies 1 (a step S12). Specifically, the operation management unit 611 determines, from the plurality of movable bodies 1, the movable body 1 to which a task related to the operation indicated by the operation order information is assigned. When the operation order information indicates a plurality of operations, the operation management unit 611 determines, from the plurality of movable bodies 1, a plurality of movable bodies 1 to which a plurality of tasks related to the plurality of operations indicated by the operation order information are assigned, respectively.

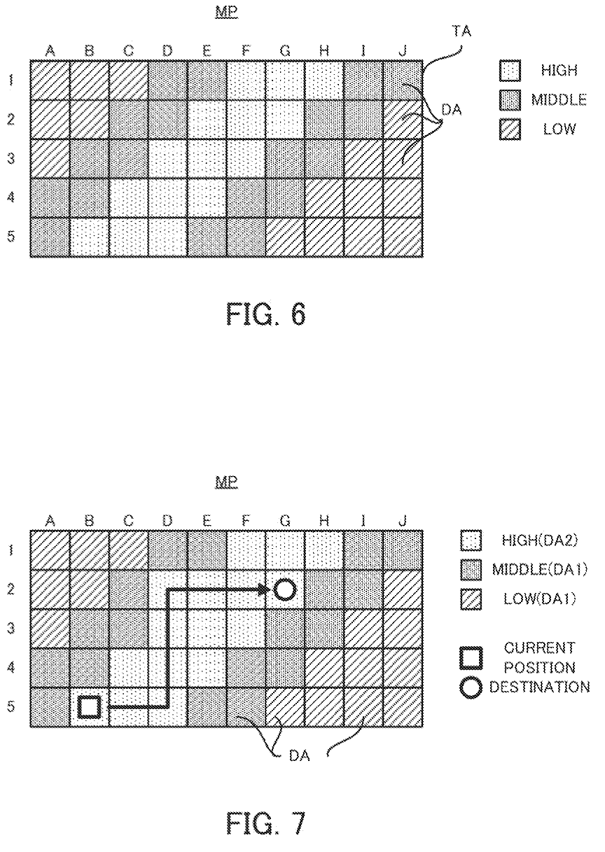

Then, the map management unit 612 maps the signal strength measured by the plurality of signal strength measurement apparatuses 3 on the movement map MP indicating the map of the transport area TA in which the plurality of movable bodies move (a step S13). FIG. 6 illustrated one example of the movement map MP on which the signal strength is mapped. As illustrated in FIG. 6, the signal strength is mapped on the movement map MP by a unit of a plurality of unit areas DA that are obtained by segmentizing the movement map MP. Thus, the movement map MP indicates the signal strength in each of the plurality of unit areas DA. The movement map MP indicates the signal strength at each of a plurality of locations in the transport area TA. In an example illustrated in FIG. 6, the signal strength classified into three strength levels having “high”, “middle” and “low”. However, the number of the level of the mapped signal strength may be two or less, or may be four or more. Moreover, in the example illustrated in FIG. 6, the movement map MP is segmentized into the plurality of unit areas DA distributing in a matrix aspect, however, the movement map MP may be segmentized into the plurality of unit areas DA distributing in another manner.

The movement map MP may include a static information related to the transport area TA. The static information is an information that has no or low possibility of changing from moment to moment. An information related to a rule that should be observed wen the movable body 1 moves in the transport area TA is one example of the static information. At least one of an information related to a location at which the movable body 1 should stop, an information related to a limitation of moving direction of the movable body 1 (namely, a limitation of one-way traffic) and an information related to a location which the movable body 1 should not enter is one example of the information related to the rule.

The movement map MP may include a dynamic information related to the transport area TA. The dynamic information is an information that has a certain or high possibility of changing from moment to moment. An information related to a position of the human existing in the transport area TA, an information related to a position of the obstacle existing in the transport area TA and an information related to a position of the movable body 1 existing in the transport area TA are examples of the dynamic information. Incidentally, it can be said that the information related to the signal strength mapped on the movement map MP is one example of the dynamic information.

This movement map MP realizes a real-time visualization of the signal strength in the transport area TA. Namely, this movement map MP realizes a real-time visualization of the communication quality of the wireless communication network NW built in the transport area TA.

Then, the route generation unit 613 generates, based on the movement map MP on which the signal strength is mapped at the step S13, the target moving route TGT for each movable body 1 in the transport area TA (a step S14). Specifically, the route generation unit 613 generates the target moving route TGT satisfying such a signal strength condition that the movable body 1 is movable in the transport area TA to avoid the unit area DA in which the signal strength is lower than a desired strength (in the below described description, it is referred to as a “low strength area DA1”). Namely, the route generation unit 613 generates the target moving route TGT avoiding the low strength area DA1 in the transport area TA. In other words, the route generation unit 613 generates the target moving route TGT satisfying such a signal strength condition that the movable body 1 is movable in the transport area TA to pass through the unit area DA in which the signal strength is equal to or higher than the desired strength (in the below described description, it is referred to as a “high strength area DA2”). Namely, the route generation unit 613 generates the target moving route TGT passing through the high strength area DA2 in the transport area TA. The desired strength corresponds to a threshold value that allows the signal strength in a situation where the communication between the movable body 1 and the control server 6 is stable to be distinguished from the signal strength in a situation where the communication between the movable body 1 and the control server 6 is unstable. Note that the low strength area DA1_lowl is one specific example of a “low quality area”.

The route generation unit 613 may generate the target moving route TGT by using an existing route generation method. For example, the route generation unit 613 may generate the target moving route TGT by using an existing route generation method based on an A* (A star) algorithm. In this case, in order to generate the target moving route TGT avoiding the low strength area DA1, the route generation unit 613 may set a cost for the low strength area DA1 to be higher than a cost for the high strength area DA2 and may generate the target moving route TGT so that a total cost of the unit areas DA through which the target moving route TGT passe is smaller (typically, is minimum).

FIG. 7 illustrates one example of the target moving route TGT satisfying the signal strength condition. FIG. 7 illustrates the target moving route TGT generated at a timing when the movable body 1 located in the unit area DA at a coordinate (B, 5) starts to move to a destination that is set in the unit area DA at a coordinate (G, 2). Incidentally, in the present example embodiment, the coordinate of the unit area DA is represented by using coordinate in which a coordinate in a horizontal direction in a drawing is represented by an alphabet and a coordinate in a vertical direction in a drawing is represented by a number, for the purpose of description. In an example illustrated in FIG. 7, the route generation unit 613 generates the target moving route TGT that allows the movable body 1 to move while avoiding the unit area DA in which the signal strength is a “middle level” or a “low level”. The route generation unit 613 generates the target moving route TGT that allows the movable body 1 to move while passing through the unit area DA in which the signal strength is a “high level”. Specifically, the route generation unit 613 generates the target moving route TGT that reaches the unit area DA at the coordinate (G, 2) from the unit area DA at a coordinate (B, 5) while passing through the unit area DA at a coordinate (C, 5), the unit area DA at a coordinate (D, 5), the unit area DA at a coordinate (D, 4), the unit area DA at a coordinate (D, 3), the unit area DA at a coordinate (D, 2), the unit area DA at a coordinate (E, 2) and the unit area DA at a coordinate (F, 2) in this order. Therefore, in this case, the signal strength condition includes such a condition that the movable body 1 is movable while avoiding the unit area DA in which the signal strength is the middle level or the low level. The signal strength condition includes such a condition that the movable body 1 is movable while passing through the unit area DA in which the signal strength is the high level. Namely, in this case, the unit area DA in which the signal strength is the middle level or the low level is the low strength area DA1 and the unit area DA in which the signal strength is the high level is the high strength area DA2.

Note that the route generation unit 613 may set the signal strength condition freely. However, it is preferable that the route generation unit 613 set the signal strength condition so as to realize a state where the movable body 1 is movable while the movable body 1 and the control server 6 properly communicate with each other.

As described above, the communication quality in the wireless communication network NW that is built by the plurality of wireless access points 2 is better as the signal strength is higher. Thus, it may be regarded that the signal strength condition that allows the movable body 1 to be movable to avoid the low strength area DA1 is substantially equivalent to a condition that a condition that allows the movable body 1 to be movable to avoid the unit area DA in which the communication quality does not reach the desired quality.

In order to generate the target moving route TGT, the route generation unit 613 may use at least one of the detected result by the plurality of detection apparatuses 13 that are included in the plurality of movable bodies 1, respectively, and the detected results by the plurality of detection apparatuses 4. Specifically, the detected result by the plurality of detection apparatuses 13 and the plurality of detection apparatuses 4 includes an information related to the object in the transport area TA. The route generation unit 613 may generate the target moving route TGT satisfying not only the above described signal strength condition but also a collision prevention condition that the movable body 1 is movable in the transport area TA to avoid the object detected at least one of the plurality of detection apparatuses 13 and the plurality of detection apparatuses 4

In order to generate the target moving route TGT satisfying the collision prevention condition, the route generation unit 613 may use the plurality of target moving routes TGT that are generated for the plurality of movable bodies 1, respectively. Specifically, the route generation unit 613 may generate the target moving route TGT so that the target moving routes TGT for the plurality of movable bodies 1 do not intersect with each other in the transport area TA. This is because at least two of the plurality of movable bodies 1 do not collide with each other when the target moving routes TGT for the plurality of movable bodies 1 do not intersect with each other in the transport area TA. Alternatively, the route generation unit 613 may generate the target moving route TGT so that at least two movable bodies 1 of the plurality of movable bodies 1 do not exist in the same unit area DA (namely, the same location) at the same time. Even in this case, at least two of the plurality of movable bodies 1 do not collide with each other.

Then, the route generation unit 613 determines whether or not the target moving route TGT satisfying the signal strength condition (furthermore, the collision prevention condition, if necessary) can be generated (a step S15).

As a result of the determination at the step S15, when it is determined that the target moving route TGT satisfying the signal strength condition can be generated (the step S15: Yes), the movable body control unit 614 controls the movable body 1 through the wireless communication network NW so that the movable body 1 moves along the target moving route TGT generated at the step S14 (a step S16). As a result, the movable body 1 starts to move.

On the other hand, as a result of the determination at the step S15, when it is determined that the target moving route TGT satisfying the signal strength condition cannot be generated (the step S15: No), there is a possibility that the movable body 1 passes through the low strength area DA1 after the movable body 1 starts to move. Therefore, there is a possibility that the communication between the movable body 1 and the control server 6 is unstable. In this case, the control server 6 generates the target moving route TGT satisfying the signal strength condition by repeating the operations at and after the step S13.

### 2) Second Movable Body Control Operation (After the Movable Body 1 Starts to Move)

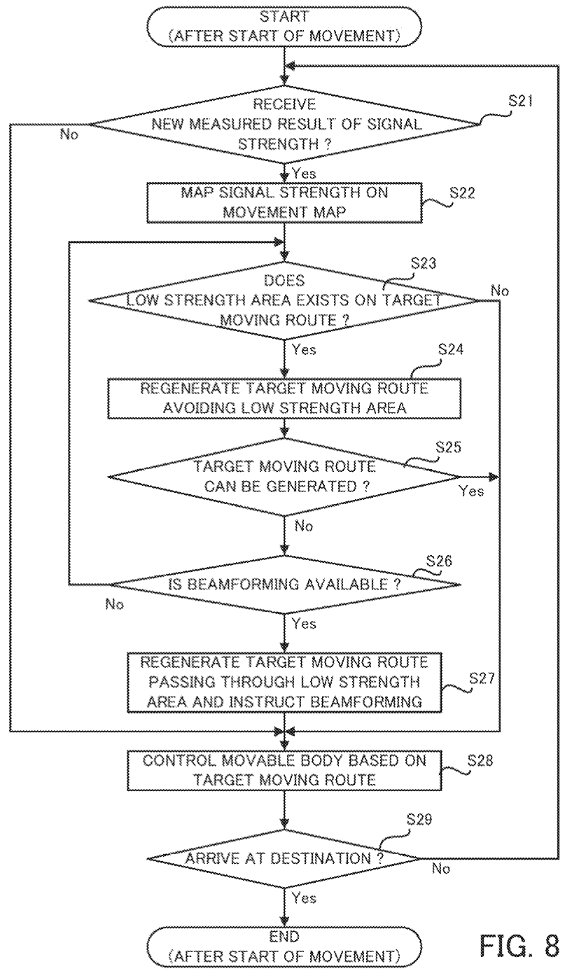

Next, with reference to FIG. 8, the second movable body control operation performed at after each movable body 1 starts to move in the transport area TA will be described. FIG. 8 is a flowchart that illustrates a flow of the second movable body control operation performed after each movable body 1 starts to move in the transport area TA. Note that the control server 6 performs the second movable body control operation individually (in other words, in parallel) for each of the plurality of movable bodies 1.

As illustrated in FIG. 8, the map management unit 612 determines that a new measured result of the signal strength by each signal strength measurement apparatus 3 is received from each signal strength measurement apparatus 3 (a step S21).

As a result of the determination at the step S21, when it is determined that the new measured result of the signal strength by each signal strength measurement apparatus 3 is not received (the step S21: No), the movable body control unit 614 controls the movable body 1 through the wireless communication network NW so that the movable body 1 moves along the target moving route TGT already generated (a step S28).

On the other hand, as a result of the determination at the step S21, when it is determined that the new measured result of the signal strength by each signal strength measurement apparatus 3 is received (the step S21: Yes), the map management unit 612 maps, on the movement map MP, the signal strength newly measured by each signal strength measurement apparatus 3 (a step S22). Namely, the map management unit 612 updates the movement map MP by using the new measured result of the signal strength by each signal strength measurement apparatus 3. Therefore, in the present example embodiment, the updated signal strength is reflected in the movement map MP in real time.

When the movement map MP is updated, there is a possibility that the movable body 1 moving along the target moving route TGT already generated passes through the low strength area DA1. This is because there is a possibility that the unit area DA in which the signal strength is equal to or higher than the desired strength before the movement map MP is updated turns into the unit area DA in which the signal strength is lower than the desired strength due to the update of the movement map MP. Thus, the route generation unit 613 determines whether or not the low strength area DA1 exists on the target moving route TGT already generated (namely, the target moving route TGT along which the movable body 1 currently moves) (a step S23).

As a result of the determination at the step S23, when it is determined that the low strength area DA1 does not exist on the target moving route TGT already generated (the step S23: No), the movable body 1 moving along the target moving route TGT already generated does not pass through the low strength area DA1. Thus, in this case, the movable body control unit 614 controls the movable body 1 through the wireless communication network NW so that the movable body 1 moves along the target moving route TGT already generated (the step S28).

On the other hand, as a result of the determination at the step S23, when it is determined that the low strength area DA1 exists on the target moving route TGT already generated (the step S23: Yes), the route generation unit 613 regenerates the target moving route TGT based on the movement map MP updated at the step S22 (a step S24). Note that the operation at the step S24 may be same as the operation at the step S14. Namely, the route generation unit 613 regenerates the target moving route TGT satisfying the signal strength condition that the movable body 1 is movable in the transport area TA to avoid the low strength area DA1. Moreover, the route generation unit 613 may regenerates the target moving route TGT satisfying the collision prevention condition.

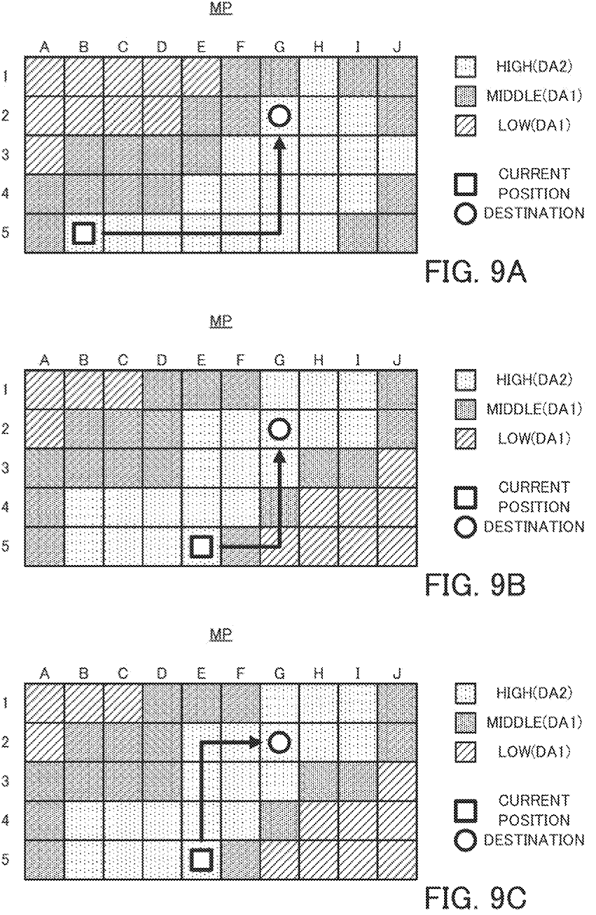

FIG. 9A to FIG. 9C illustrate one example of the target moving route TGT regenerated at the step S24. FIG. 9A illustrates, on the movement map MP that is not yet updated, the target moving route TGT generated before the movement map MP is updated. FIG. 9B illustrates, on the movement map MP that is already updated, the target moving route TGT generated before the movement map MP is updated. As illustrated in FIG. 9A and FIG. 9B, each of the unit are DA at the coordinate (F, 5), the unit are DA at the coordinate (G, 5) and the unit are DA at the coordinate (G, 4), through which the target moving route TGT generated before the movement map MP is updated passes, turns into the low strength area DA1 due to the update of the movement map MP. In this case, as illustrated in FIG. 9C, the route generation unit 613 generates new target moving route TGT avoiding the unit are DA at the coordinate (F, 5), the unit are DA at the coordinate (G, 5) and the unit are DA at the coordinate (G, 4).

Then, the route generation unit 613 determines whether or not the target moving route TGT satisfying the signal strength condition (furthermore, the collision prevention condition, if necessary) can be generated at the step S24 (a step S25).

As a result of the determination at the step S25, when it is determined that the target moving route TGT satisfying the signal strength condition can be generated (the step S25: Yes), the movable body control unit 614 controls the movable body 1 through the wireless communication network NW so that the movable body 1 moves along the target moving route TGT regenerated at the step S24 (the step S28). As a result, the movable body 1 starts to move.

On the other hand, as a result of the determination at the step S25, when it is determined that the target moving route TGT satisfying the signal strength condition cannot be generated (the step S25: No), then, the route generation unit 613 determines whether or not at least one of the plurality of wireless access points 2 is allowed to perform the beamforming with the movable body 1 (a step S26). Especially, the route generation unit 613 determines whether or not at least one wireless access point 2 having the communication cell in which the low strength area DA1 existing on the target moving route TGT is located is allowed to perform the beamforming with the movable body 1 passing through the low strength area DA1.

As a result of the determination at the step S26, when it is determined that at least one wireless access point 2 is allowed to perform the beamforming with the movable body 1 (the step S26: Yes), the route generation unit 613 generates the target moving route TGT that does not satisfies the signal strength condition (namely, the target moving route TGT passing through the low strength area DA1) (a step S27). In this case, the movable body control unit 614 further controls the wireless access point 2 so that at least one wireless access point 2 having the communication cell in which the low strength area DA1 existing on the target moving route TGT is located performs the beamforming with the movable body 1 passing through the low strength area DA1 (the step S27). Then, the movable body control unit 614 controls the movable body 1 through the wireless communication network NW so that the movable body 1 moves along the target moving route TGT generated at the step S27 (the step S28). As a result, even when the movable body 1 passes through the low strength area DA1, the communication between the movable body 1 and the control server 6 through the wireless communication network NW is secured by the beamforming. Namely, even when the movable body 1 passes through the low strength area DA1, there is a relatively low possibility that the communication between the movable body 1 and the control server 6 is unstable.

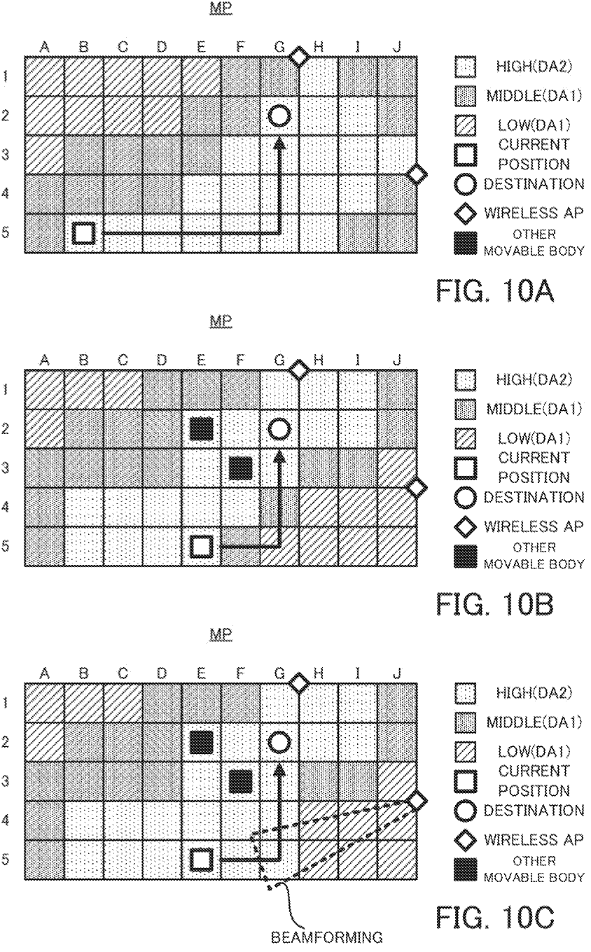

FIG. 10A to FIG. 10C illustrate one example of the wireless access point 2 performing the beamforming. FIG. 10A illustrates, on the movement map MP that is not yet updated, the target moving route TGT generated before the movement map MP is updated. FIG. 10B illustrates, on the movement map MP that is already updated, the target moving route TGT generated before the movement map MP is updated. As illustrated in FIG. 10A and FIG. 10B, each of the unit are DA at the coordinate (F, 5), the unit are DA at the coordinate (G, 5) and the unit are DA at the coordinate (G, 4), through which the target moving route TGT generated before the movement map MP is updated passes, turns into the low strength area DA1 due to the update of the movement map MP. Furthermore, as illustrated in FIG. 10B, the target moving route TGT avoiding the low strength area DA1 and avoiding other movable body 1 cannot be generated after the movement map MP is updated. Thus, in this case, as illustrated in FIG. 10C, the movable body control unit 614 allows the movable body 1 to pass through the low strength area DA1 at the coordinate (F, 5), the low strength area DA1 at the coordinate (G, 5) and the low strength area DA1 at the coordinate (G, 4). Furthermore, as illustrated in FIG. 10C, the movable body control unit 614 allows the wireless access point 2 having the communication cell in which the low strength area DA1 at the coordinate (F, 5), the low strength area DA1 at the coordinate (G, 5) and the low strength area DA1 at the coordinate (G, 4) are located to perform the beamforming with the movable body 1 passing through the low strength area DA1 at the coordinate (F, 5), the low strength area DA1 at the coordinate (G, 5) and the low strength area DA1 at the coordinate (G, 4).

On the other hand, as a result of the determination at the step S26, when it is determined that at least one wireless access point 2 is not allowed to perform the beamforming with the movable body 1 (the step S26: No), there is a possibility that the communication between the movable body 1 and the control server 6 is unstable at a timing when the movable body 1 passes through the low strength area DA1. I this case, the control server 6 generates the target moving route TGT satisfying the signal strength condition by repeating the operations at and after the step S23.

The above described operations are repeated until the movable body 1 reaches the destination (a step S29).

### Technical Effect of Movable Body Control System SYS

As described above, the movable body control system SYS (especially, the control server 6) in the present example embodiment is capable of generating the target moving route TGT avoiding the low strength area DA1 based on the movement map MP on which the signal strength updated in real time is mapped. Thus, there is a relatively low possibility that the movable body 1 passes through the low strength area DA1 after the movable body 1 starts to move. Therefore, there is a relatively low possibility that the communication between the movable body 1 and the control server 6 is unstable. Thus, the movable body 1 is capable of moving in the transport area TA properly under the control of the control server 6.

The control server 6 is capable of generating the target moving route TGT that allows the movable body 1 to move while avoiding the low strength area DA1 before the movable body 1 reaches the low strength area DA1. In this case, there is a lower possibility that the movable body 1 passes through the low strength area DA1 after the movable body 1 starts to move. Therefore, there is a lower possibility that the communication between the movable body 1 and the control server 6 is unstable. Thus, the movable body 1 is capable of moving in the transport area TA more properly under the control of the control server 6.

When the target moving route TGT avoiding the low strength area DA1 cannot be generated, the control server 6 allows the movable body 1 to move along the target moving route TGT passing through the low strength area DA1 while preventing the communication between the movable body 1 and the control server 6 from being unstable by using the beamforming of the wireless access point 2. Thus, it is possible to maximize an opportunity for the movable body 1 to move in the transport area TA while preventing the communication between the movable body 1 and the control server 6 from being unstable. Incidentally, in the above described description, the beamforming is performed when it is determined that the target moving route TGT avoiding the low strength area DA1 cannot be generated in the second movable body control operation. However, the beamforming may be performed when it is determined that the target moving route TGT avoiding the low strength area DA1 cannot be generated in the first movable body control operation.

The control server 6 is capable of performing the movable body control operation individually (in other words, in parallel) for each of the plurality of movable bodies 1. Therefore, even when the movable body control system SYS includes the plurality of movable bodies 1, the plurality of movable bodies 1 are capable of properly moving.

### Modified Example

In the above described description, the movable body control system SYS includes the plurality of signal strength measurement apparatuses 3. However, the movable body control system SYS may include at least one communication quality measurement apparatus that is configured to measure the communication quality of the wireless communication network NW built by the plurality of wireless access points 2 in the transport area TA, in addition to or instead of at least one of the plurality of signal strength measurement apparatuses 3. The communication quality measurement apparatus may be configured to measure a S/N ratio of a wireless signal, for example. in this case, the control server 6 may perform the above described movable body control operation by using a measured result by the communication quality measurement apparatus, in addition to or instead of the measured result by the signal strength measurement apparatus 3.

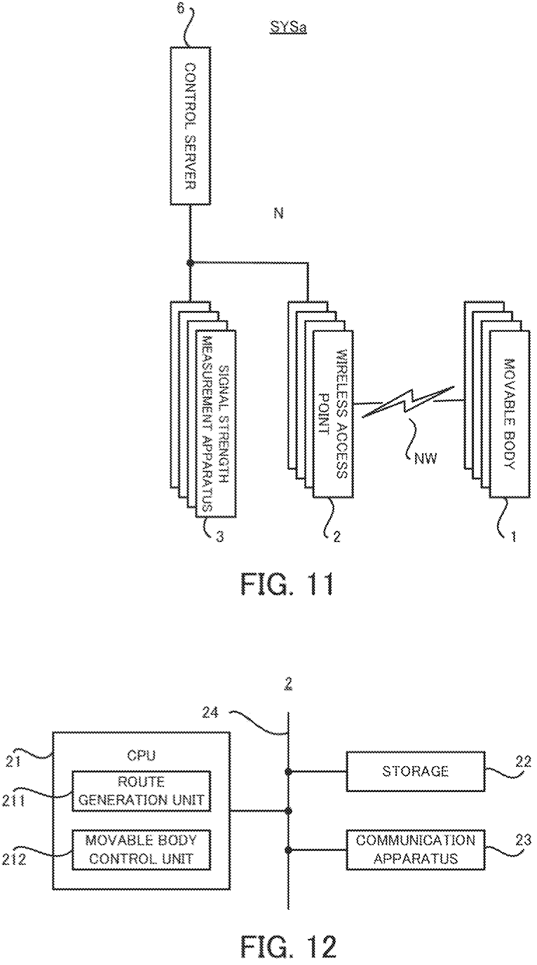

In the above described description, the movable body control system SYS includes the plurality of detection apparatuses 4. However, as illustrated in FIG. 11 that illustrates a configuration of a movable body control system SYSa in the modified example, the movable body control system SYSa may not include the detection apparatuses 4. Moreover, in the above described description, the movable body control system SYS includes the operation server 5. However, as illustrated in FIG. 11 that illustrates the configuration of the movable body control system SYSa in the modified example, the movable body control system SYSa may not include the operation server 5. In this case, the operation that is performed by the operation server 5 may be performed by the control server 6.

In the above described description, the control server 6 includes the operation management unit 611, the map management unit 612, the route generation unit 613 and the movable body control unit 614. However, as illustrated in FIG. 12 that illustrates a configuration of a control server 6a in the modified example, the control server 6a may not include at least one of the operation management unit 611 and the map management unit 612. In this case, the operation that is performed by at least one of the operation management unit 611 and the map management unit 612 may be performed by the route generation unit 613. Alternatively, the route generation unit 613 may generate the target moving route TGT based on the measured results by the plurality of signal strength measurement apparatuses 3, in addition to or instead of the movement map MP on which the signal strength is mapped.

### <5> Supplementary Note

With respect to the example embodiments described above, the following Supplementary Notes will be further disclosed.

### Supplementary Note 1

A movable body control system including:
a movable body that is movable in a predetermined area in which a wireless communication network is built;
a control apparatus that is configured to control the movable body through the wireless communication network; and
a measurement apparatus that is configured to measure a communication quality of the wireless communication network in the predetermined area,
the control apparatus including:
a generation unit that is configured to generate, as a target moving route for the movable body, a first route avoiding a low quality area in which the communication quality does not reach a desired quality in the predetermined area, based on a measured result by the measurement apparatus; and
a control unit that is configured to control the movable body so that the movable body moves along the target moving route.

### Supplementary Note 2

The movable body control system according to the Supplementary Note 1 including a plurality of movable bodies, wherein
the generation unit is configured to generate, as the target moving route for each movable body, the first route avoiding the low quality area and other movable body of the plurality of movable bodies that is different from each movable body,
the control unit is configured to control the plurality of movable bodies so that each movable body moves along the target moving route for each movable body.

### Supplementary Note 3

The movable body control system according to the Supplementary Note 1 or 2, wherein

the generation unit is configured to generate the first route as the target moving route in advance before the movable body reaches the low quality area.

### Supplementary Note 4

The movable body control system according to any one of the Supplementary Notes 1 to 3, wherein
the movable body is configured to communicate with the control apparatus through a wireless access point that is disposed in the predetermined area so as to build the wireless communication network,
the generation unit is configured to generate, as the target moving route, a second route passing through the low quality area, when the first route cannot be generated,
the control unit is configured to control the wireless access point to perform a beamforming with respect to the movable body passing through the low quality area, when the second route is generated as the target moving route.

### Supplementary Note 5

The movable body control system according to the Supplementary Note 4 including a plurality of movable bodies, wherein
the generation unit is configured to generate, as the target moving route for one movable body, the second route that passes through the low quality area and that avoids other movable body of the plurality of movable bodies, when the first route cannot be generated as the target moving route for the one movable body of the plurality of movable bodies,
the control unit is configured to control the wireless access point to perform the beamforming with respect to the one movable body passing through the low quality area, when the second route is generated as the target moving route.

### Supplementary Note 6

A control apparatus that is configured to control, through a wireless communication network, a movable body that is movable in a predetermined area in which the wireless communication network is built,
the control apparatus including:
a generation unit that is configured to generate, as a target moving route for the movable body, a first route avoiding a low quality area in which a communication quality does not reach a desired quality in the predetermined area, based on a measured result of the communication quality of the wireless communication network in the predetermined area; and
a control unit that is configured to control the movable body so that the movable body moves along the target moving route.

### Supplementary Note 7

A control method of controlling, through a wireless communication network, a movable body that is movable in a predetermined area in which the wireless communication network is built,
the control method including:
generating, as a target moving route for the movable body, a first route avoiding a low quality area in which a communication quality does not reach a desired quality in the predetermined area, based on a measured result of the communication quality of the wireless communication network in the predetermined area; and
controlling the movable body so that the movable body moves along the target moving route.

### Supplementary Note 8

A recording medium on which a computer program that allows a computer to execute a control method is recorded, wherein
the control method
is a control method of controlling, through a wireless communication network, a movable body that is movable in a predetermined area in which the wireless communication network is built, and
includes:
generating, as a target moving route for the movable body, a first route avoiding a low quality area in which a communication quality does not reach a desired quality in the predetermined area, based on a measured result of the communication quality of the wireless communication network in the predetermined area; and
controlling the movable body so that the movable body moves along the target moving route.

### Supplementary Note 8

A computer program that allows a computer to execute a control method, wherein
the control method
is a control method of controlling, through a wireless communication network, a movable body that is movable in a predetermined area in which the wireless communication network is built, and
includes:
generating, as a target moving route for the movable body, a first route avoiding a low quality area in which a communication quality does not reach a desired quality in the predetermined area, based on a measured result of the communication quality of the wireless communication network in the predetermined area; and
controlling the movable body so that the movable body moves along the target moving route.

This disclosure is not limited to the above described example embodiment. This disclosure is allowed to be changed, if desired, without departing from the essence or spirit of the invention which can be read from the claims and the entire specification, and a movable body control system, a control apparatus, a control method and a recording medium, which involve such changes, are also intended to be within the technical scope of this disclosure.

This application is based upon and claims the benefit of priority from Japanese Patent Application No. 2020-046675, filed on Mar. 17, 2020, and incorporates all of its disclosure herein, if legally permitted. Moreover, this application incorporates all of the publications of application and articles, if legally permitted.

### Description of Reference Codes

SYS movable body control system
1 movable body
2 wireless access point
3 signal strength measurement apparatus
4 detection apparatus
5 operation server
6 control server
61 CPU
611 operation management unit
612 map management unit
613 route generation unit
614 movable body control unit
MP movement map
DA unit area
DA1 low strength area
DA2 high strength area

What is claimed is:

1. A movable body control system comprising:
a movable body that is movable in a predetermined area in which a wireless communication network is built;
a control apparatus that is configured to control the movable body through the wireless communication network; and
a measurement apparatus that is configured to measure a communication quality of the wireless communication network in the predetermined area,
the control apparatus comprising:
at least one memory configured to store instructions; and
at least one processor configured to execute the instructions to:
generate, as a target moving route for the movable body, a first route avoiding a low quality area in which the communication quality does not reach a desired quality in the predetermined area, based on a measured result by the measurement apparatus; and
control the movable body so that the movable body moves along the target moving route.

2. The movable body control system according to claim 1 comprising a plurality of movable bodies, wherein
the at least one processor is configured to execute the instructions to:
generate, as the target moving route for each movable body, the first route avoiding the low quality area and other movable body of the plurality of movable bodies that is different from each movable body; and
control the plurality of movable bodies so that each movable body moves along the target moving route for each movable body.

3. The movable body control system according to claim 1, wherein the at least one processor is configured to execute the instructions to generate the first route as the target moving route in advance before the movable body reaches the low quality area.

4. The movable body control system according to claim 1, wherein
the movable body is configured to communicate with the control apparatus through a wireless access point that is disposed in the predetermined area so as to build the wireless communication network,
the at least one processor is configured to execute the instructions to:
generate, as the target moving route, a second route passing through the low quality area, when the first route cannot be generated; and
control the wireless access point to perform a beamforming with respect to the movable body passing through the low quality area, when the second route is generated as the target moving route.

5. The movable body control system according to claim 4 comprising a plurality of movable bodies, wherein
the at least one processor is configured to execute the instructions to:
generate, as the target moving route for one movable body, the second route that passes through the low quality area and that avoids other movable body of the plurality of movable bodies, when the first route cannot be generated as the target moving route for the one movable body of the plurality of movable bodies, and
control the wireless access point to perform the beamforming with respect to the one movable body passing through the low quality area, when the second route is generated as the target moving route.

6. (canceled)

7. A control method of controlling, through a wireless communication network, a movable body that is movable in a predetermined area in which the wireless communication network is built,
the control method including:
generating, as a target moving route for the movable body, a first route avoiding a low quality area in which a communication quality does not reach a desired quality in the predetermined area, based on a measured result of the communication quality of the wireless communication network in the predetermined area; and
controlling the movable body so that the movable body moves along the target moving route.

8. A non-transitory recording medium on which a computer program that allows a computer to execute a control method is recorded, wherein
the control method
is a control method of controlling, through a wireless communication network, a movable body that is movable in a predetermined area in which the wireless communication network is built, and includes:
generating, as a target moving route for the movable body, a first route avoiding a low quality area in which a communication quality does not reach a desired quality in the predetermined area, based on a measured result of the communication quality of the wireless communication network in the predetermined area; and
controlling the movable body so that the movable body moves along the target moving route.
